(19) United States
(12) Patent Application Publication
(10) Pub. No.: US 2004/0120753 A1
(43) Pub. Date: Jun. 24, 2004

(54) Powder applicator for cosmetic use

(76) Inventor: Gerard Gieux, Paris (FR)

Correspondence Address: STEVENS, DAVIS, MILLER & MOSHER, L.L.P., Suite 850, 1615 L Street, N.W., Washington, DC, 20036, US

(21) Appl. No.: 10/730,980

(22) Filed: Dec. 10, 2003

(30) Foreign Application Priority Data
Dec. 12, 2002 (FR) 02 15726
Dec. 26, 2002 (FR) 02 16719

(51) Int. Cl. B05C 19/04

(52) U.S. Cl. 401/200; 401/202

(57) ABSTRACT

A powder applicator includes a reservoir for powder and a porous membrane tensioned over the reservoir. A portion of the powder is stored in the vicinity of the membrane, in a very open synthetic foam pad between the reservoir and the membrane and communicating with the reservoir.

### BACKGROUND OF THE INVENTION

1. Field of the Invention

The present invention relates to a powder applicator for cosmetic use.

2. Description of the Prior Art

An object routinely referred to as a “powder applicator” can advantageously be used to apply a cosmetic powder to the skin. This is known in the art.

The patent application 2001-0026125 filed in South Korea on 28 Aug. 2001 discloses a powder applicator of the type including a powder applicator including a reservoir for powder, a porous membrane tensioned over the reservoir, and storage means for storing a portion of the powder in the vicinity of the membrane.

In the above prior art powder applicator, the storage means are formed by a latex bulb fixed to the reservoir.

The latex bulb has a concave region for storing the powder in the vicinity of the porous membrane and a passage allowing the powder to migrate from said reservoir toward said concave region.

Although the above prior art powder applicator applies a cosmetic powder correctly to the skin, it has the main disadvantage of being very costly to manufacture, in particular because it is necessary to use a latex bulb.

An object of the present invention is to provide a powder applicator of the type mentioned above that is significantly less costly than the prior art powder applicator.

### SUMMARY OF THE INVENTION

The above object of the invention is achieved by a powder applicator including a reservoir for powder, a porous membrane tensioned over the reservoir, and storage means for storing a portion of the powder in the vicinity of the membrane, communicating with the reservoir and including a very open synthetic foam pad between the reservoir and the membrane.

Thanks to these features, the prior art bulb can be replaced by a simple synthetic foam pad that communicates with the reservoir and is significantly less costly than the prior art bulb.

Moreover, and this is important, powder can be stored inside the pad because the synthetic foam forming the pad has a very open structure.

This improves the efficacy of the powder applicator relative to the use of a latex bulb, which is too dense to soak up the powder.

According to other optional features of the powder applicator according to the invention:

the powder applicator includes a first grid between the reservoir and the pad and fastened to the reservoir,

the first grid is domed and its concave side faces the reservoir,

the powder applicator includes a second grid mounted to rotate relative to the first grid between a service position in which orifices of the grids face each other and a storage position in which the orifices are offset relative to each other,

the second grid is domed and espouses the shape of the first grid,

the orifices of at least one of the grids have a section that diminishes in the direction from the reservoir toward the pad,

the powder applicator includes a ring with an inside edge adapted to clamp the periphery of the membrane against one of the grids,

the powder applicator includes a ring with an inside edge adapted to clamp the periphery of the membrane against the pad,

the membrane has a portion covering the edge of the face of the pad that faces the reservoir,

the pad has a groove receiving the inside edge of the ring,

the ring is conformed to conceal the connection region between the membrane and the reservoir,

the peripheral face of the pad is at least partly covered by an envelope made of a synthetic foam that is harder than the foam forming the pad,

the envelope has a groove receiving the interior edge of the ring,

the envelope is interrupted at the groove,

the envelope is set back relative to the face of the pad that is against the membrane,

the pad is machined to a mushroom shape,

the envelope is conformed to espouse the mushroom shape of the pad,

an exterior wall of the membrane is flocked,

the membrane has pores with an average diameter of the order of 0.1 mm distributed at the rate of approximately 130 pores per centimeter,

the pad has pores with an average diameter of the order of 2 mm distributed at the rate of approximately eight pores per centimeter.

Other features and advantages of the present invention will become apparent on reading the following description and examining the appended drawings.

### BRIEF DESCRIPTION OF THE DRAWINGS

FIG. 1 is an exploded perspective view of a first embodiment of a powder applicator according to the invention.

FIG. 2 is a view of said powder applicator in axial section.

FIGS. 3 to 13 are views in axial section of other variants of a powder applicator according to the invention (partial views in the case of FIGS. 7 to 13).

### DETAILED DESCRIPTION OF THE PREFERRED EMBODIMENTS

In the above figures, the same reference numbers designate identical or similar items or groups of items.

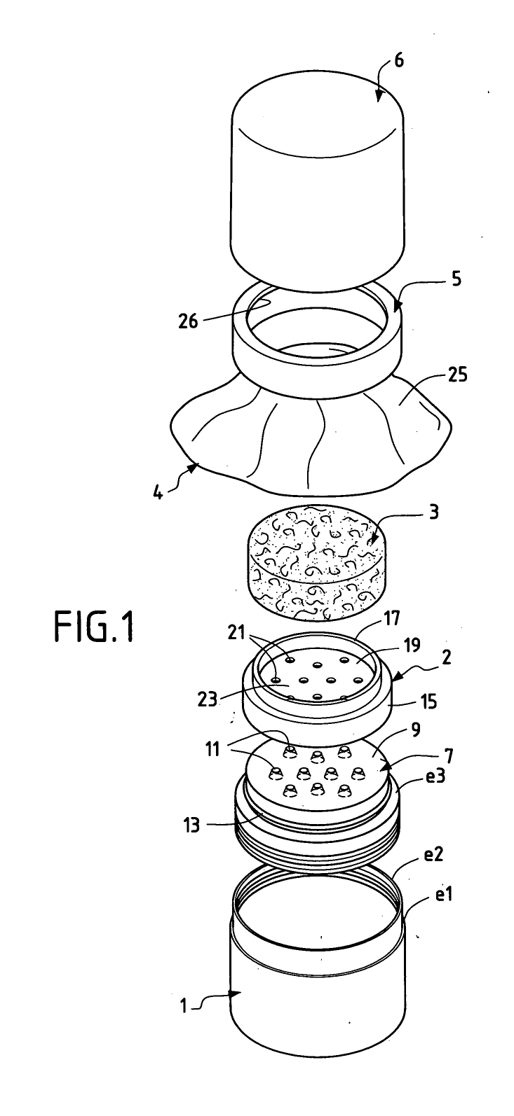

FIG. 1 shows a first embodiment of a powder applicator according to the invention that includes mainly a powder reservoir 1, a lid 7, a selector 2, a synthetic foam pad 3, a porous membrane 4, a ring 5 and a protective cap 6.

The powder reservoir 1 can be substantially cylindrical with a shoulder e1.

The lid 7 includes a reservoir grid 9 with a plurality of orifices 11 and is conformed to define two more shoulders e2 and e3.

The lid 7 preferably has a small annular bead 13 at its periphery and in the region of the shoulder e3.

The lid 7 is connected to the reservoir 1 by any appropriate means such as gluing, clipping, etc.

The selector 2 has a skirt 15 adapted to nest over the shoulder e3 on the lid 7.

On top of the skirt 15 is a substantially annular wall 17 extending around a selection grid 19 with a plurality of orifices 21. The annular wall 17 and the selection grid 19 define a housing 23.

The pad 3 is preferably substantially cylindrical so that it can be placed in the housing 23 of the selector 2.

The synthetic foam forming the pad 3 is very open, i.e. it comprises large-diameter pores communicating freely with each other.

For example, said pores can have an average diameter of the order of 2 mm and there can be approximately eight pores per centimeter.

The membrane 4 is substantially disk-shaped with a diameter significantly larger than that of the housing 23 formed in the selector 2.

The membrane 4 can also be formed of a synthetic foam, but a foam much less open than the foam forming the pad 3.

For example, the pores of the membrane 4 can have an average diameter of the order of 0.1 mm and there can be approximately 130 pores per centimeter.

The exterior wall 25 of the membrane 4 is preferably flocked, i.e. covered with very fine nylon fibers making it softer to the touch.

The inside diameter of the ring 5 is slightly larger than the outside diameter of the skirt 15 of the selector 2.

Moreover, the upper portion of the ring 5 includes a rim 26 extending toward the interior of the ring and having an inside diameter slightly larger than the outside diameter of the annular wall 17 of the selector 2.

The ring 5 is adapted to nest over the shoulder e2 defined by the lid 7.

The protective cap 6, which can be transparent, is adapted to nest over the shoulder e1 on the reservoir 1.

The powder reservoir 1, the selector 2, the ring 5 and the protective cap 6 can be molded from plastics materials.

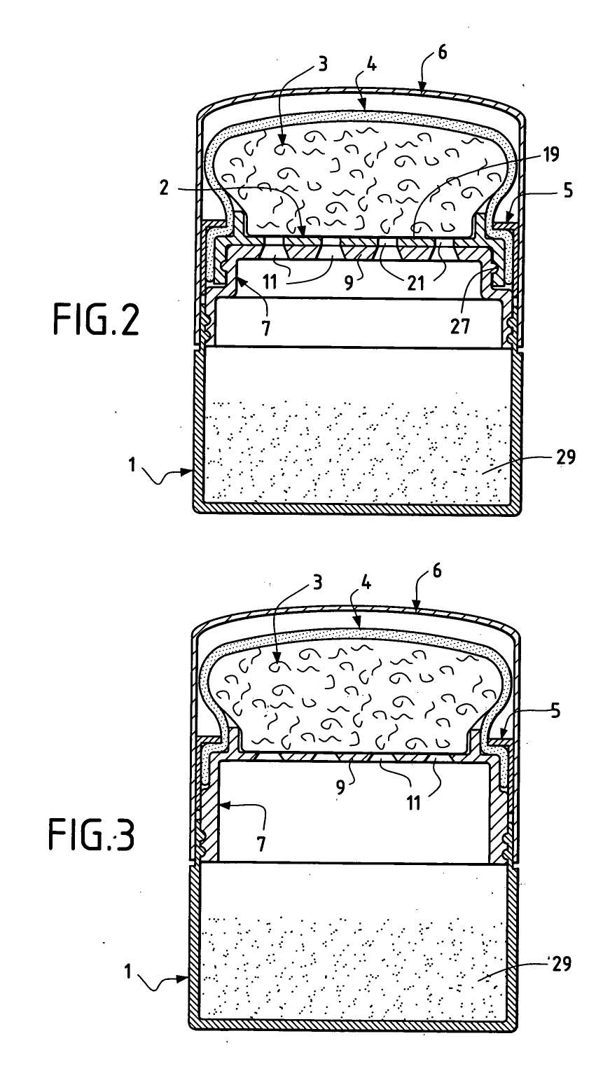

FIG. 2 shows how the items described hereinabove cooperate with each other.

The skirt 15 of the selector 2 has on its inside face a groove 27 cooperating with the small bead 13, thereby enabling the selector 2 to be clipped onto the lid 7 but also enabling these two components to rotate relative to each other.

FIG. 2 shows the powder applicator in a service configuration, i.e. with the orifices 21 in the selection grid 19 of the selector 2 aligned with the orifices 11 in the reservoir grid 9.

In this configuration, said orifices therefore form passages enabling the powder 29 to migrate from the reservoir 1 toward the compartment 23 of the selector 2.

The powder applicator according to the invention has another configuration known as the storage configuration, not shown, in which the orifices 11 and 21 are offset from each other by pivoting the selector 2 relative to the lid 7.

Migration of the powder 29 from the reservoir 1 toward the compartment 23 is prevented in the storage configuration.

The pad 3 is disposed inside the compartment 23 and occupies substantially all of its volume.

The membrane 4 is tensioned over the selector 2 and held in place on the selector 2 by the ring 5, whose interior profile corresponds, apart from a slight clearance, to the exterior profile of the selector 2.

It will be noted that the orifices 11 and possibly the orifices 21 preferably have a section that reduces in size from the reservoir 1 toward the compartment 23.

The operation and the advantages of the powder applicator according to the invention follow directly from the foregoing description.

When the powder 29 in the reservoir 1 is to be applied to the skin, the powder applicator is set to the service configuration shown in FIG. 2.

The powder applicator is then tipped slightly to cause some of the powder 29 to migrate into the pad 3 through the passages defined by the orifices 11 and 21.

Because the synthetic foam forming the pad 3 has a very open structure, a large quantity of powder can be stored in the pad.

The porous membrane 25 can be applied to the skin and tapped gently to cause powder to exit the pad 3 and to migrate through the membrane 4 onto the skin.

When the user has finished with the powder applicator according to the invention, it is set to its storage configuration.

To this end, the selector 2 is pivoted relative to the lid 7 so that the orifices 11 and 21 are offset from each other, thereby preventing the powder 29 leaving the reservoir 1.

As is clear from the foregoing description, the structure defined by the passages 11, 21 and the pad 3 makes it possible to dispense with the prior art bulb whilst providing an improved powder storage capacity in the immediate vicinity of the membrane 4.

The material of the pad 3 being significantly less costly than that forming the prior art bulb, the powder applicator according to the invention can be manufactured at very low cost.

It will be noted that, being distributed over the whole of the surface of the selection grid 19 of the selector 2 and of the reservoir grid 9 of the lid 7, the passages 11, 21 distribute the powder homogeneously in the pad 3, so making the powder applicator according to the invention more efficient and more comfortable to use.

One of the diverse advantages of the powder applicator according to the invention is that the method of fixing the membrane 4 to the selector 2, i.e. wedging it by means of the ring 5, enables the use of a membrane formed in one piece, unlike the membrane of the prior art powder applicator, which had to be designed to cover the bulb, which necessarily implied that the membrane had to be formed of two parts welded together.

As a result of this, the exterior face of the porous membrane carried a weld line that seriously compromised the general aesthetics of the powder applicator.

Note that because the membrane 4 is tensioned, the pad 3 assumes a flared shape, as shown in FIG. 2, i.e. a shape that projects from the wall 17 of the selector 2, thus improving the aesthetics of the powder applicator.

Note also that, because of this flared shape, the pad 3 can cover the upper edge of the wall 17 and at least a portion of the ring 5, which prevents the hard portions of the powder applicator discomforting the user.

Note further that the pad 3 could have dimensions slightly greater than those of the housing 23 before being inserted therein, so that it has to be compressed slightly to place it in the housing and, once fitted, tends to project from the housing.

Note also that because the ring 5 is adapted to nest over the shoulder e2, it can therefore conceal the region connecting the membrane 4 with the selector 2 and the selector with the lid 7, thereby further enhancing the finish of the powder applicator.

Note also that the densities and the dimensions of the pores of the materials forming the pad 3 and the membrane 4 can be adapted as a function of the nature of the powder 29 to be applied to the skin, in particular its particle size range.

Similarly, the relative thickness of the pad and the membrane can be modified.

Note that the protective cap 6 is aligned with the exterior wall of the reservoir 1 when it is in place on the shoulder e1, which contributes to improving the aesthetics of the powder applicator.

Note further that the presence of the selector 2, although preferred, is in fact optional.

In a more economical embodiment of the powder applicator according to the invention shown in FIG. 3, the selector 2 is dispensed with and the pad 3 is placed directly on the reservoir grid 9 and the membrane 4 is fixed directly to the lid 7.

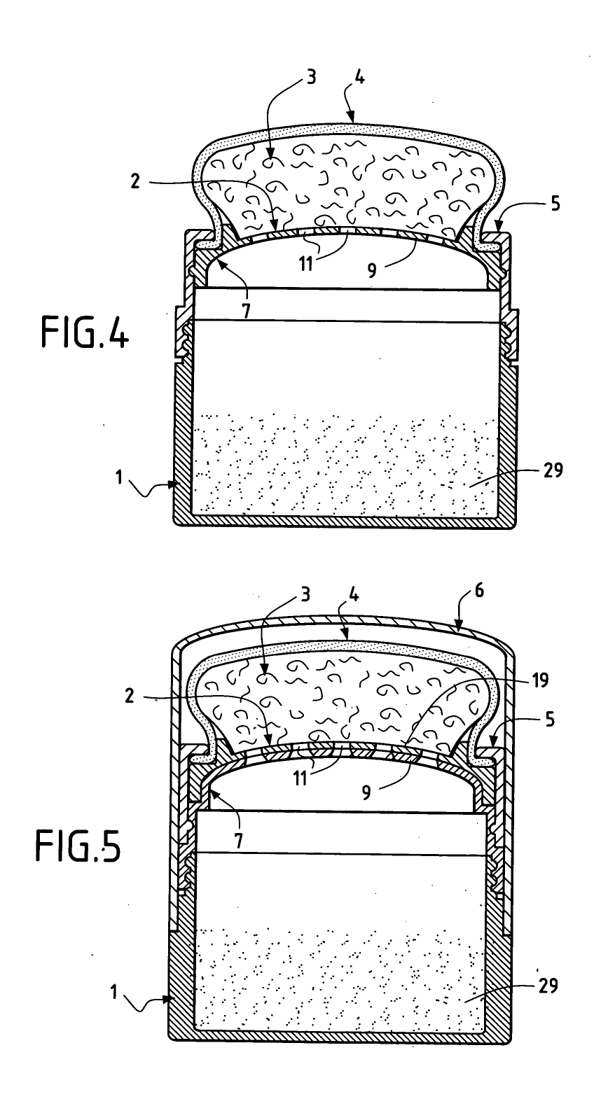

In the embodiment shown in FIG. 4, the reservoir grid 9 is domed and its concave side faces toward the reservoir 1.

In the embodiment shown in FIG. 5, the reservoir grid 9 and selection grid 19 are both domed and their shapes espouse each other.

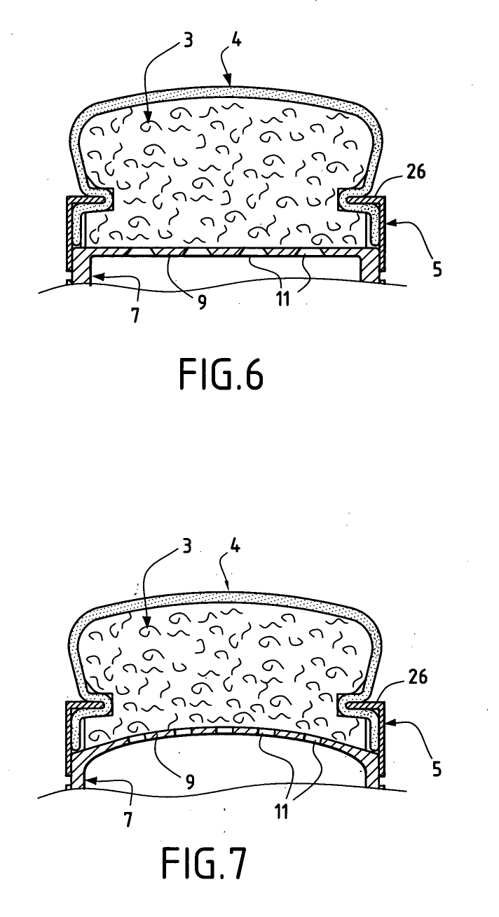

In the embodiment shown in FIG. 6, the reservoir grid 9 is flat and the pad 3 has a groove 31 at its periphery in which the inside edge 26 of the ring 5 engages.

As a result, the membrane 4 is held wedged against the bottom of the groove 31 by the inside edge 26.

This is a very simple way to immobilize the pad 3 and the membrane 4.

The embodiment shown in FIG. 7 differs from the preceding one in that the reservoir grid 9 is domed.

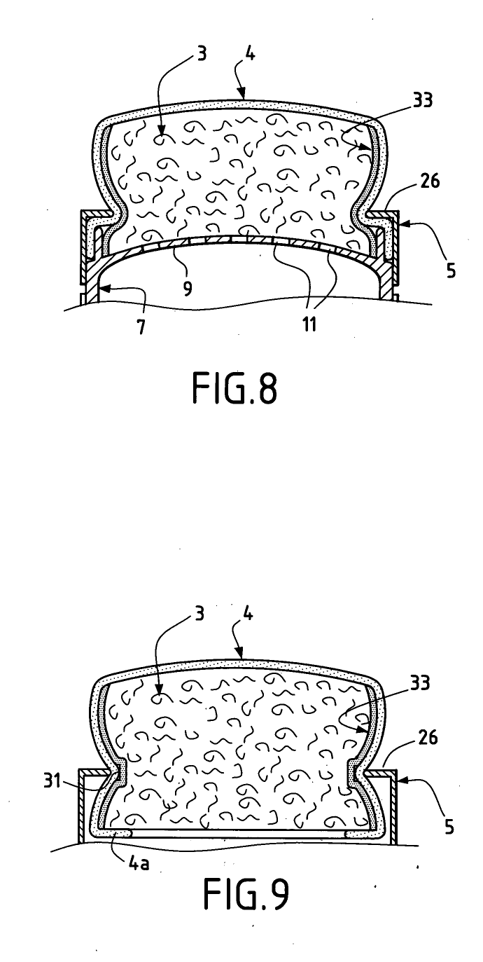

In the embodiment shown in FIG. 8, the reservoir grid 9 is domed and the foam pad 3 is covered by an envelope 33 made of a synthetic foam that is harder than the foam forming the pad, so as to confer some stiffness on the combination of the pad 3, the envelope 33 and the membrane 4.

The pad 3 and the membrane 4 are held by the pressure exerted by the inside edge 26 of the ring 5.

The embodiment shown in FIG. 9 differs from the preceding one in that there is no grid between the pad 3 and the reservoir 1 and the synthetic foam envelope 33 has a groove 31 at its periphery in which the inside edge 26 of the ring 5 engages.

Thus the membrane 4 is held wedged into the bottom of the groove 31 by the inside edge 26.

Note further that in the embodiment shown in FIG. 9 the membrane 4 has a portion 4a that covers the edge of the face of the pad 3 that faces the reservoir 1.

The membrane 4 therefore envelops practically all of the pad 3, with the result that the membrane and the pad form a compact assembly whose fitting is greatly simplified.

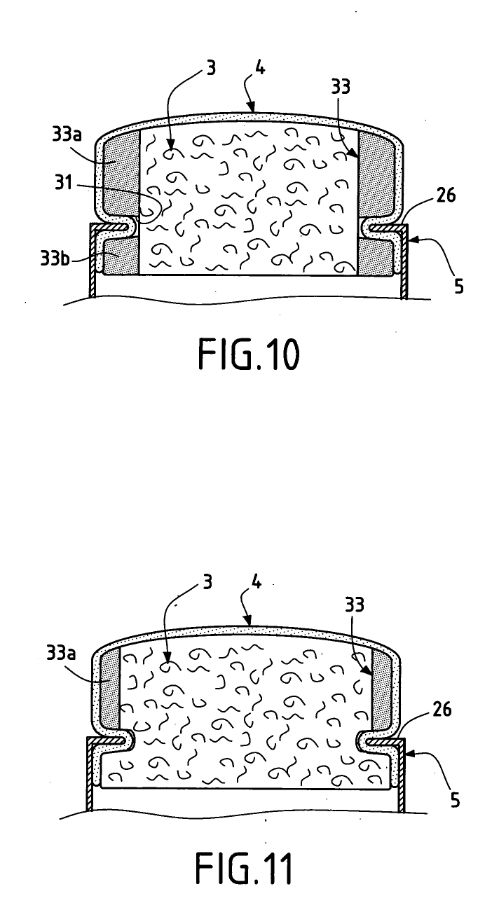

The embodiment shown in FIG. 10 differs from the preceding one in that the synthetic foam envelope 33 is divided into two portions 33a and 33b defining a groove 31 in which the inside edge 26 of the ring 5 engages.

The embodiment shown in FIG. 11 differs from the preceding one in that the synthetic foam envelope 33 has only an upper portion 33a, situated above the inside edge 26 of the ring 5.

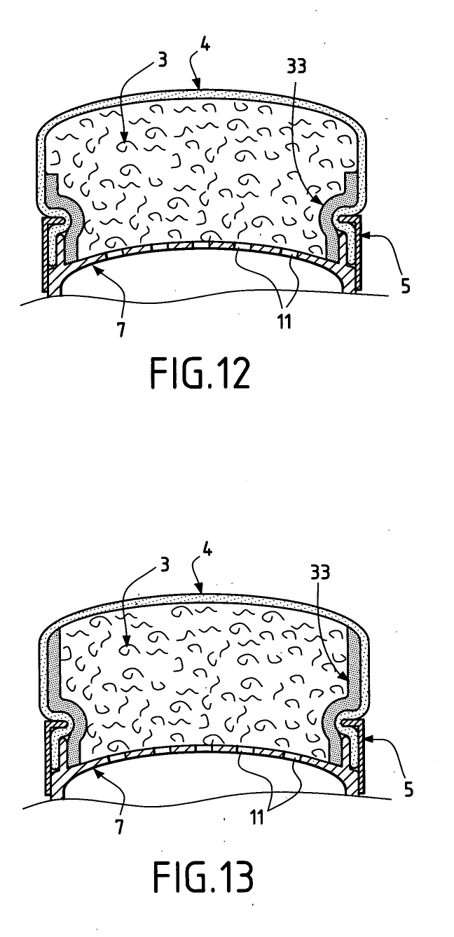

The embodiment shown in FIG. 12 differs from the embodiment shown in FIG. 8 in that the pad 3 is machined so that it has substantially the shape of a mushroom, the synthetic foam envelope 33 being set back relative to the face of the pad 3 that is in contact with the membrane 4.

This prevents the synthetic foam envelope 33 coming into contact with the skin of the user.

The embodiment shown in FIG. 13 differs from the preceding one in that the synthetic foam envelope 33 extends to the height of the face of the pad 3 that is in contact with the membrane 4.

In the embodiments shown in FIGS. 6 to 13, having the membrane 4 formed of two portions welded together can be envisaged, the weld line then being disposed so that it can be hidden by the ring 5 and by its inside edge 26.

Of course, the present invention is not limited to the embodiments described and shown, which are provided by way of illustrative and nonlimiting example.

Thus other embodiments can be envisaged that combine the features of the embodiments described hereinabove.

For example, eliminating the reservoir grid 9 in the embodiments shown in FIGS. 12 and 13 or using a membrane like that from FIG. 9 (i.e. having a portion 4a) in the embodiments shown in FIGS. 4 to 8 and 10 to 13 could be envisaged.

There is claimed:

1. A powder applicator including a reservoir for powder, a porous membrane tensioned over said reservoir, and storage means for storing a portion of said powder in the vicinity of said membrane, communicating with said reservoir and including a very open synthetic foam pad between said reservoir and said membrane.

2. The powder applicator claimed in claim 1 including a first grid between said reservoir and said pad and fastened to said reservoir.

3. The powder applicator claimed in claim 2 wherein said first grid is domed and its concave side faces said reservoir.

4. The powder applicator claimed in claim 2 including a second grid mounted to rotate relative to said first grid between a service position in which orifices of said grids face each other and a storage position in which said orifices are offset relative to each other.

5. The powder applicator claimed in claim 4 wherein said first grid is domed and its concave side faces said reservoir said second grid is domed and espouses the shape of said first grid.

6. The powder applicator claimed in claim 2 wherein said orifices of at least one of said grids have a section that diminishes in the direction from said reservoir toward said pad.

7. The powder applicator claimed in claim 2 including a ring with an inside edge adapted to clamp the periphery of said membrane against one of said grids.

8. The powder applicator claimed in claim 1 including a ring with an inside edge adapted to clamp the periphery of said membrane against said pad.

9. The powder applicator claimed in claim 8 wherein said membrane has a portion covering the edge of the face of said pad that faces said reservoir.

10. The powder applicator claimed in claim 8 wherein said pad has a groove receiving said inside edge of said ring.

11. The powder applicator claimed in claim 7 wherein said ring is conformed to conceal the connection region between said membrane and said reservoir.

12. The powder applicator claimed in claim 1 wherein the peripheral face of said pad is at least partly covered by an envelope made of a synthetic foam that is harder than the foam forming said pad.

13. The powder applicator claimed in claims 8 and 12 including a ring with an inside edge adapted to clamp the periphery of said membrane against said pad and wherein said envelope has a groove receiving the interior edge of said ring.

14. The powder applicator claimed in claims 10 and 12 wherein said pad has a groove receiving said inside edge of said ring and said envelope is interrupted at said groove.

15. The powder applicator claimed in claim 12 wherein said envelope is set back relative to the face of said pad that is against said membrane.

16. The powder applicator claimed in claim 1 wherein said pad is machined to a mushroom shape.

17. The powder applicator claimed in claim 16 wherein said envelope is conformed to espouse said mushroom shape of said pad.

18. The powder applicator claimed in claim 1 wherein an exterior wall of said membrane is flocked.

19. The powder applicator claimed in claim 1 wherein said membrane has pores with an average diameter of the order of 0.1 mm distributed at the rate of approximately 130 pores per centimeter.

20. The powder applicator claimed in claim 1 wherein said pad has pores with an average diameter of the order of 2 mm distributed at the rate of approximately eight pores per centimeter.
